(19) United States
(12) Patent Application Publication
(10) Pub. No.: US 2010/0179458 A1
(43) Pub. Date: Jul. 15, 2010

(54) VIBROACOUSTIC SOUND THERAPEUTIC SYSTEM AND METHOD

(76) Inventors: David Venturi, Oakville (CA); T. Russell Shivas, Toronto (CA); Dieter D. Doederlein, Mississauga (CA)

Correspondence Address: FOLEY & LARDNER LLP, 111 HUNTINGTON AVENUE, 26TH FLOOR, BOSTON, MA, 02199-7610, US

(21) Appl. No.: 12/575,817

(22) Filed: Oct. 8, 2009

Related U.S. Application Data
(63) Continuation of application No. 11/258,660, filed on Oct. 26, 2005, now abandoned.

(51) Int. Cl. A61H 1/00

(52) U.S. Cl. 601/47

(57) ABSTRACT

The present invention provides a vibroacoustic sound therapeutic system including an acoustic energy source having means for generating an acoustic drive signal, the acoustic drive signal being characterized by a frequency sweep between a relatively low frequency and a relatively high frequency, and one or more acoustic transducers adapted for operation in a liquid medium, the transducers being responsive to the acoustic drive signal to generate acoustic energy at frequencies corresponding to frequencies of the acoustic drive signal.

### FIELD OF THE INVENTION

The present invention relates to vibroacoustic sound therapeutic systems, and more particularly, to methods of and systems for using audible sound vibrations to promote health, invoke relaxation and alleviate stress.

### BACKGROUND

Vibroacoustic therapy is a technique in which a combination of two different sounds are played to a patients: music to relax and focus the mind; and a pulsed low frequency tone to relax and “massage” the body. The physical experience of this combination of sounds can lead to a reduction in muscle stress, blood pressure and heart rate. While music on its own can be very relaxing, it is the pulsed low frequency tone that makes vibroacoustic therapy special.

Every music tone vibrates at a different speed or frequency. Vibrational frequency is measured in cycles per second, or hertz (Hz). Frequencies above 20,000 Hz are considered ultrasonic, while those below 20 Hz are termed infrasonic. Humans are able to hear frequencies between 20 Hz and 20,000 Hz. Vibroacoustic therapy uses frequencies within the range of human hearing. Low frequency ranges are most strongly felt and may contribute to a greater experience of relaxation and/or pain and symptom relief.

Vibroacoustic music uses sound vibration for tactile stimulation and, in some models, for listening. The sound/music is experienced both as physiological vibration and as a psychological event. The conceptual model for music and music vibration for pain relief explains this as the two-pronged approach: engaging psychological processes (music listening) together with physiological processes (transcutaneously applied music vibration) activates pain-suppressive efferent neural activity as well as pain suppressive afferent neural activity. In conjunction, the two prongs also integrate somatic and auditory neural activity that may provide for synergistic mechanisms in the central nervous system.

Three possible explanations for the positive effects of vibroacoustic are: vibroacoustic music sessions trigger the relaxation response with benefits for pain and symptom reduction, as well as tension, fatigue, headache, nausea, and depression; stimulation of the Pacinian corpuscle at frequencies between 60 Hz and 600 Hz creates neuronal inhibition of pain; and vibration may assist in cellular cleansing mechanisms with possible positive effects on health and illness.

A primary outcome of the vibroacoustic experience is the initiation of a state of deep relaxation, called the relaxation response. This mental, physical, and emotional state is characterized by lowered blood pressure and decreased heart, breathing, and metabolic rates.

A benefit of vibroacoustic music might result from stimulation of the Pacinian corpuscles, large mechanoreceptors located in the subcutaneous and connective tissues surrounding visceral organs and joints. These bulb-like structures surrounding nerve endings are sensitive to pressure. The Pacinian corpuscle can react to stimulation by vibroacoustic technology in the 60 Hz to 600 Hz range known to affect these mechanoreceptors. When stimulated, the Pacinian corpuscle sends neurological nonpain messages to the brain that appear to inhibit the pain impulse.

The positive effects of vibroacoustic can also refer to the effects of vocalized vibrations upon the brain. The vibrations felt in the body or initiated by vocalization are conducted via bone and membrane structures and assist with diffusion of large molecules and toxins out of the brain.

There are three main vibroacoustic equipment designs in the prior art. A full-frequency music (FFM) model is the most widely used. This equipment uses one sound source and plays music using a wide range of frequencies. Preferably, it plays prerecorded music designed for vibroacoustic music or music with high vibroacoustic effects and is highly practical because of the simplicity of the system and consequent ease of use. Another design, called quantified mechanical vibration (QMV), is a music vibration table, used to deliver measured vibrations and monitor the frequencies and amplitudes received at specified areas of the body. Yet another design, called selective low-frequency (SLF), uses a vibroacoustic chair with specific low frequencies for vibroacoustic stimulation. It uses a rhythmically pulsed low frequency sound programmed through a computer to resonate in specific areas of the body.

Since the vibroacoustic music usually needs to be played in a loud volume and to make vibration in order to have therapeutic effects, patients sometimes feel uncomfortable during the therapy sessions. Furthermore, long time low frequency noise can cause hearing damages or impairment. Therefore, improved systems and methods for vibroacoustic therapy are needed.

### SUMMARY OF THE INVENTION

The present invention provides an improved vibroacoustic therapy systems and methods. According to one aspect of the invention, the vibroacoustic therapeutic system includes an acoustic energy source for generating an acoustic drive signal and at least one transducer connected to the acoustic energy source and being responsive to the acoustic drive signal to generate acoustic energy at frequencies corresponding to frequencies of the acoustic drive signal.

In one preferred embodiment, a vibroacoustic therapeutic system includes an acoustic energy source for generating an acoustic drive signal, the acoustic drive signal being characterized by a frequency sweep between a relatively low frequency and a relatively high frequency, and one or more acoustic transducers adapted for operation in a liquid medium, the transducers being responsive to the acoustic drive signal to generate acoustic energy at frequencies corresponding to frequencies of the acoustic drive signal.

In one preferred embodiment, the acoustic energy source includes an acoustic signal generator for generating the acoustic drive signal. In one preferred form, the acoustic signal generator includes a communications circuit board, a multi-channel audio process board, and an audio signal amplifier. The acoustic signal is preferably software controlled and originates from a computer through a connection (USB), which transmits the acoustic signal to the communications circuit board. The acoustic signal is then processed by the multi-channel audio processing board and amplified by the audio signal amplifier. The acoustic energy source further includes an output, preferably an XLR connector for connecting with an input of the transducer.

The acoustic drive signal generated by the acoustic energy source is preferably characterized by a frequency sweep between a relatively low frequency and a relatively high frequency. The at least one transducer is adapted for operation in a liquid medium, and is responsive to the acoustic drive signal to generate acoustic energy at frequencies corresponding to frequencies of the acoustic drive signal.

In one preferred embodiment of the invention, the frequency sweep is periodic. In another preferred aspect of the invention, the frequency sweep is aperiodic.

In a preferred embodiment of the present invention, the frequency sweep is symmetrical about a center frequency. In another embodiment of the present invention, the frequency sweep is asymmetrical.

In yet another preferred embodiment of the invention, the frequency sweep is relatively slow from the low frequency to the high frequency, and is relatively rapid from the high frequency to the low frequency.

In a preferred embodiment of the invention, the frequency sweep is a piecewise succession of linear functions of time. In a preferred embodiment of the invention, the frequency sweep has a sawtooth form. In yet another preferred embodiment of the invention, the frequency sweep has a triangle form.

In another preferred embodiment of the invention, the frequency sweep is a nonlinear function of time. In a preferred embodiment of the invention, the frequency sweep has a sinusoidal form.

In a preferred embodiment of the invention, the acoustic frequency sweep is modulated. In another preferred embodiment of the invention, the frequency sweep is amplitude modulated. In yet another preferred embodiment of the invention, the frequency sweep is frequency modulated. By way of example, the modulation may be sinusoidal, sawtooth or triangular. Other modulation forms may be used. In yet another preferred embodiment of the invention, the acoustic drive signal is further characterized by an audio signal. In one preferred aspect of the invention, the acoustic drive signal is a music signal.

In a preferred aspect of the invention, the acoustic transducer includes a peripheral assembly adapted for contact with the skin of a patient whereby substantially all of the acoustic energy is coupled to the patient.

In one preferred embodiment of the invention, the frequency sweep of the acoustic drive signal is between a relatively low frequency and a relatively high frequency. Preferably, the relatively low frequency is less than 100 Hz and the relatively high frequency is greater than or equal to 1 KHz. In another preferred aspect of the invention, the relatively low frequency is approximately 60 Hz and the relatively high frequency is approximately 1 KHz. The relatively low frequency can be as low as 0 Hz. In yet another preferred embodiment of the invention, the relatively high frequency is less than 20 KHz.

The vibroacoustic therapy device according to the invention treats the whole body by resulting in at least three phenomena:

Skin Mechanoreceptor Effect: The pressure wave hits the skin, activates the mechanoreceptors in the skin, and creates a signal that goes to the brain. This signal prevents the pain fibers from being activated.

Exercise Effect: The actual composition of the sound waves causes interaction with the muscle stretch receptors, and causes the muscles to stretch with the frequency of the actual signal received which produces an exercise effect that produces certain neuro-chemicals like beta endorphins which improve pain response.

Cell Membrane Effect: People with pain, fibromyalgia and sleep deprivation have trigger points, and the acoustic wave generated in the invention decrease the triggering frequency or triggering voltage of the cell, resulting in pain relief. Furthermore, the pressure gradient and the thermal gradient helps the cell membrane change flows in arteries, veins and lymph systems. It may also increase the anti-inflammatory effect, increase the pain relief effect, and decrease muscle tone through relaxation.

According to one aspect of the present invention, the vibroacoustic therapy system includes a music system generating and playing a music to the patient through a headset, which blocks the “noise” generated by the acoustic energy generator, and also induces a relaxation response with specific sounds and frequencies from the patient. The theory behind is that tegmentum is an area of the brain where primitive responses for pleasure or for pain occur, therefore, any modification of the tegmentum with a limbic system produces a physiological response of relaxation and pain control. The major neuro-chemicals involved with this process are dopamine and serotonin. The hypothalamus secretes these chemicals, which either activate or deactivate the limbic system, inducing either sleep or wakefulness. Once the patient starts to relax, heart rate drops, blood pressure drops, breathing rate slows down, and these factors have a positive effect on people with chronic pain.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 shows a perspective view of one preferred embodiment of a vibroacoustic therapeutic system;

FIG. 2A shows an exemplary frequency sweep for an acoustic drive signal in accordance with the invention wherein the frequency sweep is triangular;

FIG. 2B shows an exemplary frequency sweep for an acoustic drive signal in accordance with the invention, wherein the frequency sweep is aperiodic;

FIG. 2C shows an exemplary frequency sweep for an acoustic drive signal in accordance with the invention, wherein the frequency sweep has a sawtooth form;

FIG. 2D shows an exemplary frequency sweep for an acoustic drive signal in accordance with the invention, wherein the frequency sweep is asymmetrical;

FIG. 2E shows an exemplary frequency sweep for an acoustic drive signal in accordance with the invention, wherein the frequency sweep has a sinusoidal form;

FIG. 2F shows an exemplary frequency sweep for an acoustic drive signal in accordance with the invention, wherein the frequency sweep has a sinusoidal amplitude modulated triangular form;

FIG. 2G shows another exemplary frequency sweep for an acoustic drive signal in accordance with the invention, wherein the frequency sweep has a triangle amplitude modulated form;

FIG. 3A shows a preferred embodiment of the vibroacoustic therapeutic system;

FIG. 3B shows another preferred embodiment of the vibroacoustic therapeutic system; and

FIG. 3C shows yet another preferred embodiment of the vibroacoustic therapeutic system.

### DESCRIPTION OF THE PREFERRED EMBODIMENTS

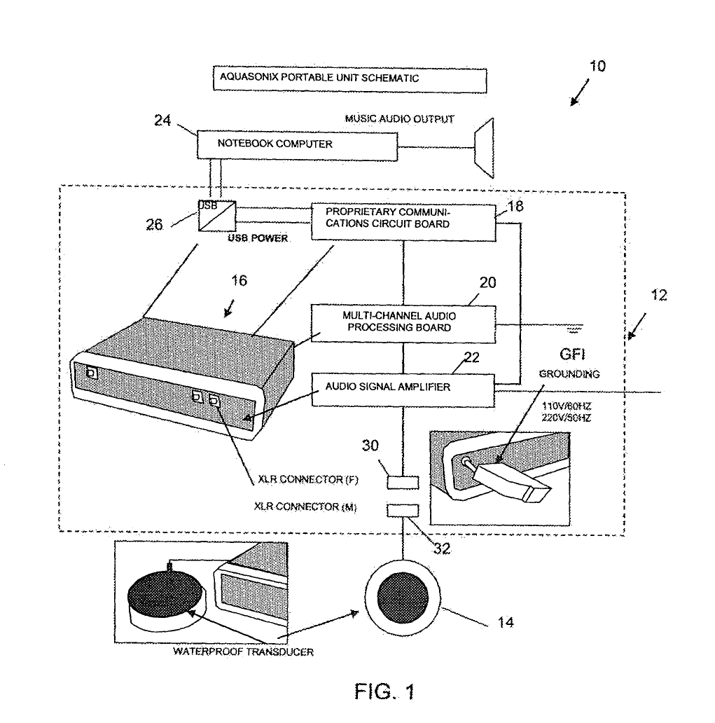

The present invention provides a vibroacoustic therapeutic system 10 as shown in FIG. 1. According to one aspect of the invention, the vibroacoustic therapeutic system 10 includes an acoustic energy source 12 for generating an acoustic drive signal and at least one transducer 14 connected to the acoustic energy source 12 and being responsive to the acoustic drive signal to generate acoustic energy at frequencies corresponding to frequencies of the acoustic drive signal.

In one preferred embodiment, the acoustic energy source 12 includes an acoustic signal generator 16 for generating the acoustic drive signal. As shown in FIG. 1, in one preferred form, the acoustic signal generator 16 includes a communications circuit board 18, a multi-channel audio process board 20, and an audio signal amplifier 22. The acoustic signal is preferably software controlled and originates from a computer 24 through a connection (USB) 26, which transmits the acoustic signal to the communications circuit board 18. The acoustic signal is then processed by the multi-channel audio processing board 20 and amplified by the audio signal amplifier 22. The acoustic energy source 12 further includes an output, preferably an XLR connector 30 for connecting with an input (e.g., an XLR connector 32) of the transducer 14.

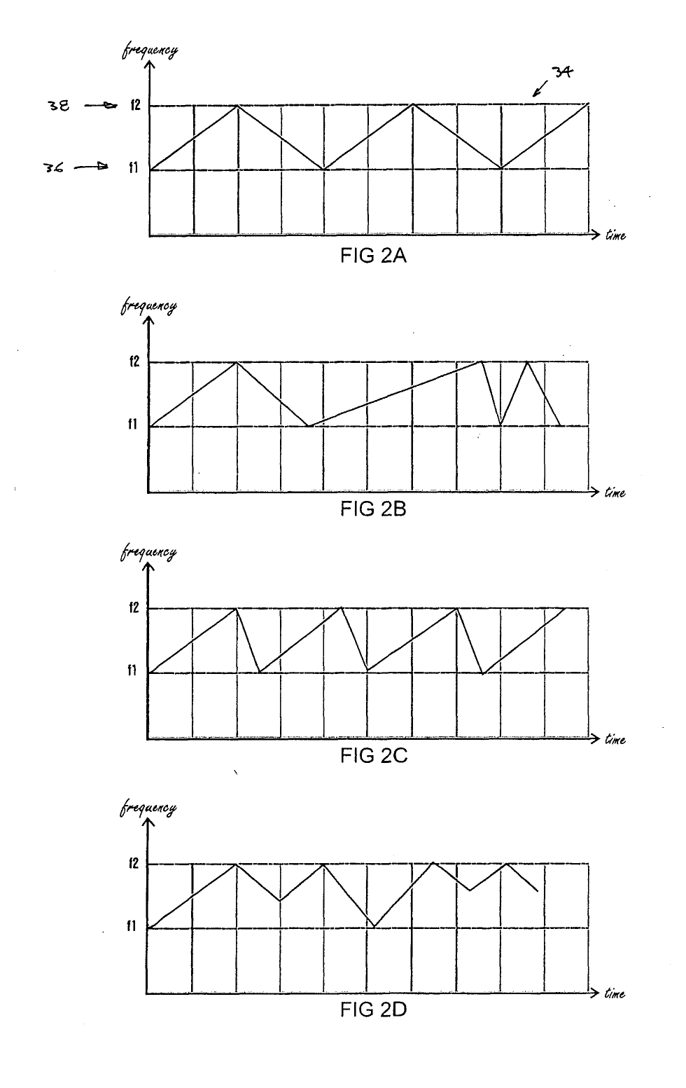

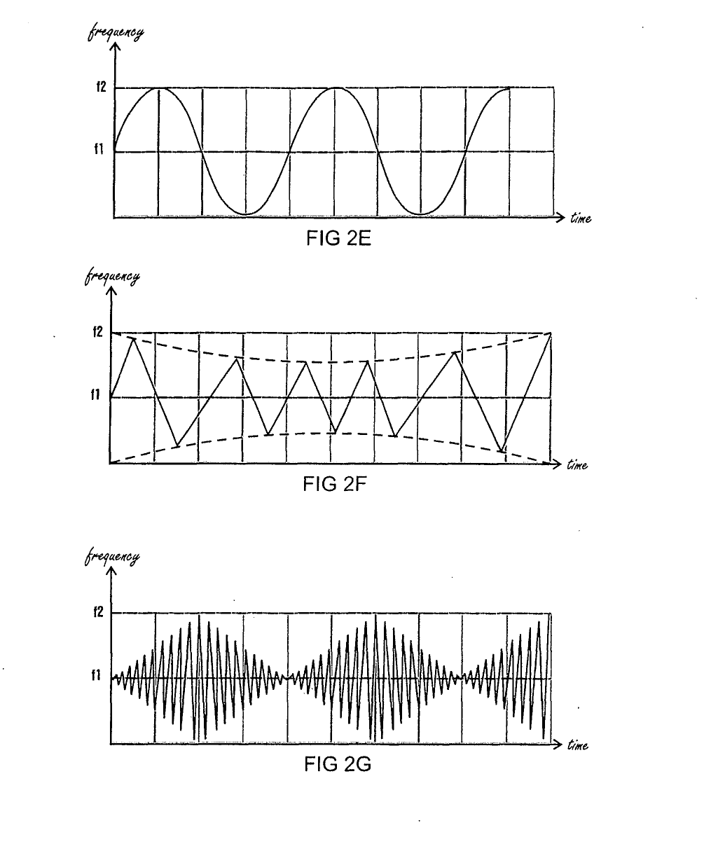

The acoustic drive signal generated by the acoustic energy source 12 is preferably characterized by a frequency (f) sweep as indicated by reference number 34 in FIG. 2A between a relatively low frequency as indicated by reference number 36 and a relatively high frequency as indicated by reference number 38. The frequency sweep in FIG. 2A has a symmetrical triangle form. The at least one transducer 14 is adapted for operation in a liquid medium, and is responsive to the acoustic drive signal to generate acoustic energy at frequencies corresponding to frequencies of the acoustic drive signal.

In one preferred embodiment of the invention, as shown in FIG. 2A, the frequency sweep 34 is periodic. In another preferred embodiment of the invention as shown in FIG. 2B, the frequency sweep 34 is aperiodic.

In a preferred embodiment of the present invention as shown in FIG. 2C, the frequency sweep 34 has a sawtooth form. In another embodiment of the present invention as shown in FIG. 2D, the frequency sweep 34 is asymmetrical.

In yet another preferred embodiment of the invention as shown in FIG. 2E, the frequency sweep 34 has a sinusoidal form.

The frequency sweeps of FIGS. 2F and 2G are each triangle-based with amplitude modulation; the sweep of FIG. 2F has a sinusoidal modulation and the sweep of FIG. 2G has a triangle modulation.

The frequency sweeps of FIGS. 2A-2D, 2F and 2G, each comprise a piecewise succession of linear functions of time

In a preferred embodiment of the invention, the acoustic drive signal is modulated. The acoustic drive signal may be amplitude modulated or frequency modulated. In yet another preferred embodiment of the invention, the acoustic drive signal is further characterized by an audio signal. In one preferred embodiment of the invention, the acoustic drive signal is a music signal.

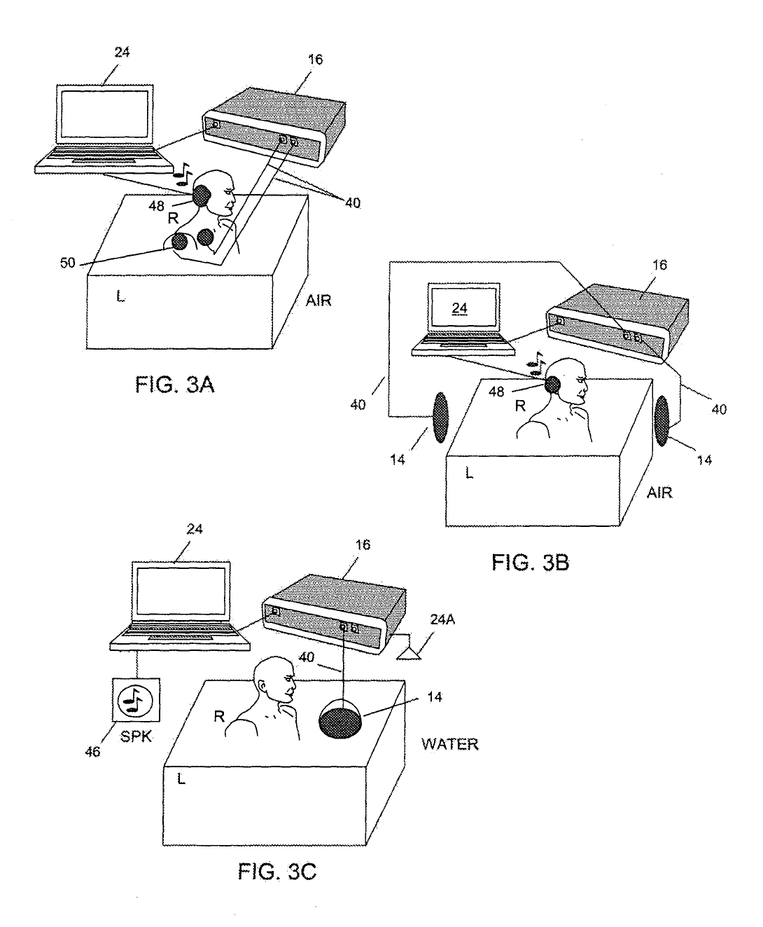

As shown in FIGS. 3A, 3B and 3C, a patient is preferably treated by the vibroacoustic therapy device of the present invention, while standing in a liquid. The patient receives music through a headset 48 or a speaker 46. The headset 48 or the speaker 46 is connected to and controlled by a music source. In one preferred form, the music source is the computer 24. The signal generator 16 for generating the acoustic drive signal is connected to the computer 24, whereby in one preferred form, the acoustic signal is originates from and controlled by the computer 24. At least one transducers 14 are connected to the acoustic signal generator 16 by at least one connecting cable 40.

In a preferred embodiment of the invention as shown in FIG. 3A, the acoustic transducers 14 include peripheral assemblies 50 adapted for contacting the skin of the patient, and thus substantially all of the acoustic energy is coupled to the patient. In another preferred embodiment of the invention as shown in FIG. 3B, the at least one acoustic transducers 14 are placed on the outer surface of the wall of the liquid container, thereby to transmit the acoustic energy to the liquid received in the container and to the patient in the liquid. In yet another preferred embodiment of the invention as shown in FIG. 3C, the at least one acoustic transducers 14 are placed in the liquid, thereby to transmit the acoustic energy to the liquid and to the patient in the liquid. In one preferred embodiment, the liquid is water.

In one preferred embodiment of the invention, the frequency sweep of the acoustic drive signal is between a relatively low frequency and a relatively high frequency. Preferably, the relatively low frequency is less than 100 Hz (but can be as low as 0 Hertz) and the relatively high frequency is greater than or equal to 1 KHz. In another preferred embodiment of the invention, the relatively low frequency is approximately 60 Hz and the relatively high frequency is approximately 1 KHz. In yet another preferred embodiment of the invention, the relatively high frequency is less than 20 KHz.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A vibroacoustic therapeutic system comprising:
A. an acoustic energy source including computer means for generating an acoustic drive signal, said acoustic drive signal being characterized by a frequency sweep between a relatively low frequency and a relatively high frequency, and
B. one or more acoustic transducers adapted for operation in a liquid medium, said transducers being responsive to said acoustic drive signal to generate acoustic energy at frequencies corresponding to frequencies of said acoustic drive signal.

2. A system according to claim 1, wherein said frequency sweep is periodic.

3. A system according to claim 1, wherein said frequency sweep is aperiodic.

4. A system according to claim 1, wherein said frequency sweep is asymmetrical.

5. A system according to claim 4, wherein said frequency sweep is relatively slow
from said low frequency to said high frequency and relatively rapid from said high frequency to said low frequency.

6. A system according to claim 1, wherein said frequency sweep is a piecewise succession of linear functions of time.

7. A system according to claim 6, wherein said frequency sweep has a sawtooth form.

8. A system according to claim 6, wherein said frequency sweep has a triangle form.

9. A system according to claim 8 wherein said frequency sweep is amplitude modulated.

10. A system according to claim 9 wherein said amplitude modulation is sinusoidal.

11. A system according to claim 9 wherein said amplitude modulation is triangular.

12. A system according to claim 1, wherein said frequency sweep is a non linear function of time.

13. A system according to claim 12, wherein said frequency sweep has a sinusoidal
form.

14. A system according to claim 1, wherein said acoustic drive signal is modulated.

15. A system according to claim 1, wherein said acoustic drive signal is amplitude modulated.

16. A system according to claim 1, wherein said acoustic drive signal is frequency modulated.

17. A system according to claim 1, wherein said acoustic drive signal is further characterized by an audio signal.

18. A system according to claim 17, wherein said acoustic drive signal is a music signal.

19. A system according to claim 1, wherein said acoustic transducers include a peripheral assembly adapted for contact with the skin of a patient, whereby substantially all of said acoustic energy is couplable to said patient.

20. A system according to claim 1, wherein said relatively low frequency is less than 100 HZ and said relatively high frequency is greater than or equal to 1 KHZ.

21. A system according to claim 20, wherein said relatively low frequency is approximately 60 HZ and said relatively high frequency is approximately 1 KHZ.

22. A system according to claim 20, wherein said relatively high frequency is less than 20 KHZ.

23. A vibroacoustic sound therapeutic method for a region of interest of a patient, comprising the steps of:
A. positioning said patient whereby said region of interest is within a liquid medium;
B. generating an acoustic drive signal via computer, said acoustic drive signal being characterized by a frequency sweep between a relatively low frequency and a relatively high frequency;
C. generating acoustic energy at frequencies corresponding to frequencies of said acoustic drive signal in a liquid medium; and
D. coupling said acoustic energy by way of said liquid medium to said region of interest of said patient.

24. A method according to claim 23, wherein said frequency sweep is periodic.

25. A method according to claim 23, wherein said frequency sweep is aperiodic.

26. A method according to claim 23, wherein said frequency sweep is asymmetrical.

27. A method according to claim 26, wherein said frequency sweep is relatively slow from said low frequency to said high frequency and relatively rapid from said high frequency to said low frequency.

28. A method according to claim 23, wherein said frequency sweep is a succession of piecewise linear functions of time.

29. A method according to claim 28, wherein said frequency sweep has a sawtooth form.

30. A method according to claim 28, wherein said frequency sweep has a triangle form.

31. A method according to claim 30 wherein said frequency sweep is amplitude modulated.

32. A method according to claim 31 wherein said amplitude modulation is sinusoidal.

33. A method according to claim 31 wherein said amplitude modulation is triangular.

34. A method according to claim 23, wherein said frequency sweep is a nonlinear function of time.

35. A method according to claim 34, wherein said frequency sweep has a sinusoidal form.

36. A method according to claim 23, wherein said acoustic drive signal is modulated.

37. A system according to claim 23, wherein said acoustic drive signal is amplitude modulated.

38. A method according to claim 23, wherein said acoustic drive signal is frequency modulated.

39. A method according to claim 23, wherein said acoustic drive signal is further characterized by an audio signal.

40. A method according to claim 39, wherein said acoustic drive signal is a music signal.

41. A method according to claim 23, wherein said relatively low frequency is less than 100 HZ and said relatively high frequency is greater than or equal to 1 KHZ.

42. A method according to claim 41, wherein said relatively low frequency is approximately 60 HZ and said relatively high frequency is approximately 1 KHZ.

43. A method according to claim 42, wherein said relatively high frequency is less than 20 KHZ.
